(19) United States
(12) Patent Application Publication
(10) Pub. No.: US 2011/0219299 A1
(43) Pub. Date: Sep. 8, 2011

(54) METHOD AND SYSTEM OF PROVIDING COMPLETION SUGGESTION TO A PARTIAL LINGUISTIC ELEMENT

(75) Inventor: Daniel Reuven Scalosub, RaAnana (IL)

(73) Assignee: DSNR Labs Ltd., RaAnana (IL)

(21) Appl. No.: 12/718,977

(22) Filed: Mar. 7, 2010

(51) Int. Cl. G06F 17/21

(52) U.S. Cl. 715/261

(57) ABSTRACT

A method of acquiring one or more completion suggestions to a partial linguistic element. The method comprises detecting a user input having at least a partial linguistic element, selecting a group from a plurality of linguistic elements according to the partial linguistic element, each member of the group having at least one common character with the partial linguistic element, identifying at least one contextual characteristic of the partial linguistic element, prioritizing members of the group according to a match between the at least one contextual characteristic and a dataset mapping a plurality of contextual characteristics of each the linguistic element, and presenting at least some of the prioritized members as at least one completion suggestion to the partial linguistic element.

### FIELD AND BACKGROUND OF THE INVENTION

The present invention, in some embodiments thereof, relates to input assistance systems and methods of and, more particularly, but not exclusively, to systems and methods of completing and/or verifying data entry.

User interfaces may include autocompletion features. For example, when a user types some text, for example characters, into a text entry field, the user interface may propose a list of possible text completions. Known systems and methods provide proposals for the possible completions which are based on, for example, text typed in so far, previous entries into the same field, or an indexing of related words, for example other words on a web page. The user may then select within a list of the proposals, by, for example, using a mouse or arrow keys, and pressing the enter key for validation.

For example, a user that starts to type the characters “real” into a text entry field may be proposed with possible completions such as “real estate” and “Real Madrid,” usually using a small choice list that pops up right below the text entry field. The user may then choose one of the proposed completions, or keep typing if none of the proposed completions matches the text that the user intends to type into the text field.

During the last years, various methods and systems have been developed to improve the autocompletion process. For example U.S. Pat. No. 6,377,965, filed on Nov. 7, 1997 describes a word completion system that can automatically predict unrestricted word completions for data entries in an unstructured portion of a data file. The word completion system applies prediction criteria to avoid displaying an excessive number of wrong suggestions. Suggested word completions, which may change as the user types a partial data entry, are displayed in a non-disruptive manner and selected using traditional acceptance keystrokes, such as the “tab” key or the “enter” key. The word completion system may be deployed on an individual application program basis or on an application-independent basis. Because different word suggestion lists may be appropriate for different application programs, and for different data files created with the same application program, the word completion system allows the user to select one or more suggestion lists for use with each data file. A user interface allows the user to customize each suggestion list on an on-going basis. Each suggestion list may contain dynamic word completions that are tied to dynamic parameters maintained by the computer system, such as the time, date, registered user, and so forth. Each suggestion list may also be tied to contextual information. such as structured data fields or context labels assigned manually or by a document-creation aid known as a “wizard”.

Another example is described in U.S. Pat. No. 7,650,348, filed, as a PCT application, on Jul. 23, 2003 which describes systems and methods of building and using a custom word list for use in text operations on an electronic device. The document describes a collection of text items, associated with a user of the electronic device, which is scanned to identify words. A weighting is assigned to each identified word, and the words and corresponding weightings are stored.

### SUMMARY OF THE INVENTION

According to some embodiments of the present invention there is provided a method of acquiring at least one completion suggestion to a partial linguistic element. The method comprises detecting a user input having at least a partial linguistic element, selecting a group from a plurality of linguistic elements according to the partial linguistic element, each member of the group having at least one common character with the partial linguistic element, identifying at least one contextual characteristic of the partial linguistic element, prioritizing members of the group according to a match between the at least one contextual characteristic and a dataset mapping a plurality of contextual characteristics of each the linguistic element, and presenting at least some of the prioritized members as at least one completion suggestion to the partial linguistic element.

Optionally, the selecting comprises receiving a descriptive information for each the linguistic element from a plurality of users, the presenting comprises presenting descriptive information of the at least some of the prioritized members.

Optionally, the detecting comprises converting a voice signal to generate the partial linguistic element.

Optionally, the selecting comprises providing at least one map segmenting the plurality of linguistic elements according to opening characters and selecting a segment of the map as the group according to the partial linguistic element.

Optionally, the identifying comprises identifying an input time of submitting the user input, the dataset mapping a plurality of input times of each the linguistic element according to an analysis of a plurality of documents.

Optionally, the identifying comprises identifying a medium type in which the user input being provided, the dataset mapping a prevalence of plurality of types of a plurality of documents in which each the linguistic element being identified.

Optionally, the identifying comprises classifying a circumstantial type of a document in which the user input being provided, the dataset mapping a prevalence of plurality of circumstantial types of a plurality of documents in which each the linguistic element being identified.

Optionally, the identifying comprises classifying a field of a document in which the user input being provided, the dataset mapping a prevalence of plurality of fields of a plurality of documents in which each the linguistic element being identified.

Optionally, the identifying comprises identifying a location in a document for which the user input being provided, the dataset mapping a prevalence of the linguistic element in a plurality of locations in a plurality of documents.

Optionally, the identifying comprises identifying a location in a sentence in which the user input being provided, the dataset mapping a prevalence of the linguistic element in a plurality of locations in a plurality of sentences in a plurality of documents.

Optionally, the identifying comprises identifying at least one characteristic of a user inputting the user input, the dataset mapping a plurality of author characteristics of a plurality of documents in which each the linguistic element being identified.

According to some embodiments of the present invention there is provided a method of providing at least one completion suggestion in response to a partial linguistic element. The method comprises providing a group selected from a plurality of linguistic elements, each member of the group having at least one common character with at least a partial linguistic element of a user input, providing at least one contextual characteristic of the partial linguistic element, matching the at least one contextual characteristic with a dataset having a plurality of entries mapping a plurality of contextual characteristics of each the linguistic element, prioritizing members of the group according to the match, and indicating the prioritization to allow a presentation of the group accordingly.

Optionally, providing at least one contextual characteristic comprises providing a user profile defining at least one characteristic of a user providing the user input the matching comprises matching the user profile with the dataset.

Optionally, the matching comprises adding at least one synonym of a linguistic element of the group to the group.

Optionally, the providing comprises receiving the group from a linguistic completion utility hosted in a client terminal.

According to some embodiments of the present invention there is provided a system of providing at least one completion suggestion to a partial linguistic element. The system comprises a repository which stores a dataset having a plurality of entries mapping a plurality of contextual characteristics of each of a plurality of linguistic element, a web analysis unit which analyzes a plurality of network documents to update the dataset, an interface which receives at least one contextual characteristic of at least a partial linguistic element and an indication of a group of the plurality of linguistic elements, the group being selected according to the partial linguistic element, and a prioritization engine which priorities members of the group according to a match between the at least one contextual characteristic and a respective group of the plurality of entries.

Optionally, each the network document is selected from a group consisting of a webpage, a media file, a data file, a peer to peer (P2P) transmission, a search query, a response to a search query, a content retrieved in response to a search query, and a resource pointed by a universal resource identifier (URI).

Optionally, the at least one contextual characteristic and the indication are received from one of a plurality of linguistic completion utilities installed on a plurality of client terminals communicating with the interface.

Optionally, the system further comprises a user analysis module which analyzes a plurality of documents composed by a plurality of users to update the dataset.

Optionally, the system further comprises a user input module which receives a plurality of manual inputs from a plurality of users and updates the dataset accordingly.

According to some embodiments of the present invention there is provided a method of maintaining a repository of a plurality of linguistic elements for prioritizing. The method comprises providing a dataset having a plurality of entries mapping a plurality of contextual characteristics of each of a plurality of linguistic elements, analyzing a plurality of documents created by a plurality of different users to statistically estimate the prevalence of at least one of the plurality of contextual characteristics for each the linguistic element, and updating the dataset according to the estimation.

Optionally, analyzing comprises assigning each the estimation with a time decreasing weight so that the effect of each appearance of the linguistic element depends on its actuality.

Optionally, the analyzing comprises monitoring a usage of the plurality of linguistic elements by each of the plurality of users during typing.

Optionally, the analyzing comprises analyzing a plurality of webpages having at least some of the plurality of linguistic elements.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a client terminal having a linguistic completion utility of providing one or more completion suggestions, according to some embodiments of the present invention;

FIG. 2 is a flowchart of a method of providing a set of linguistic elements as completion suggestions, according to some embodiments of the present invention;

FIG. 3 is a schematic illustration of a plurality of client terminals which are connected to a system of prioritizing linguistic elements according to contextual characteristics, according to some embodiments of the present invention;

FIGS. 4A-4B are schematic illustrations of windows in which the prioritized set of linguistic elements, which are selected in response to the partial linguistic element “thi”, are presented to a user, according to some embodiments of the present invention;

FIG. 4C is a schematic illustration of a window set to be displayed to a user if no completion suggestion is available, according to some embodiments of the present invention;

FIG. 5 is an exemplary schematic illustration of an array of linguistic elements and the dynamic measurements of their contextual characteristics, according to some embodiments of the present invention;

FIG. 6 is an exemplary table of the contextual characteristics of six exemplary appearances of linguistic element in six documents, according to some embodiments of the present invention; and

FIG. 7 is a flowchart of a method of providing one or more completion suggestions in response and according to at least a partial linguistic element, according to some embodiments of the present invention.

### DESCRIPTION OF EMBODIMENTS OF THE INVENTION

The present invention, in some embodiments thereof, relates to input assistance systems and methods of and, more particularly, but not exclusively, to systems and methods of completing and/or verifying data entry.

According to some embodiments of the present invention there is provided a system and method of acquiring one or more completion suggestions to at least a partial linguistic element, such as a partial word, according to some embodiments of the present invention. The completion suggestions provided to expedite an input process, such as typing by providing the user with logistic elements, such as words and sentences based on an analysis of one or more contextual characteristics of the partial linguistic element, for example the time of typing, the type of the document in which the partial linguistic element is inputted, the user profile if the inputting user, and/or an analysis of preceding linguistic elements. The method is based on detecting a user input having at least a partial linguistic element, for example two or three opening characters of a word and selecting a group from a dataset of plurality of linguistic elements according to the partial linguistic element. Optionally, the selection is based on one or more maps that segment the dataset according to different opening characters, for example to segments with common three first letters. This allows identifying a set of potential linguistic elements. Now, one or more contextual characteristics of the partial linguistic element are identified. This allows prioritizing members of the set according to the contextual characteristics of the partial linguistic element. For example, the members of the set are prioritizes according contextual characteristics which are mapped as related thereto in a dataset that maps contextual characteristics of a plurality of linguistic elements. This allows prioritizing the set according to the time of input, the medium in which the input is provided, the circumstantial reasons in which the input is provided, the location in the document and/or in the sentence of the input, the field to which the related document is related, and the like. This allows prioritizing the set according to characteristics of the author, for example his age and gender and/or his fields of interest or occupation. The dataset, which is optionally created by a statistical analysis of a plurality of documents, such as network documents, for example webpages, and user documents, for example WORD documents, maps various contextual characteristics in various documents which include the plurality of linguistic elements and created by a plurality of different users. The dataset allows prioritizing the linguistic elements in the set according to measurements based on inputs in which the contextual characteristics are similar to the contextual characteristics of the partial linguistic element.

According to some embodiments of the present invention there is provided a system of providing one or more completion suggestions to a plurality of communicating linguistic completion utilities. The system includes a repository which stores a dataset as outlined above, a web analysis unit which analyzes a plurality of network documents to update the dataset, and an interface which receives one or more contextual characteristics of at least a partial linguistic element and an indication of a group of linguistic elements, which is optionally selected according to the partial linguistic element, from one of the communicating linguistic completion utilities. The system further includes a prioritization engine which priorities members of the group according to a match between the one or more contextual characteristics and a respective group from the database.

Optionally, the system further includes a user analysis module which analyzes a plurality of user documents to estimate the contextual characteristics and update the dataset accordingly.

Additionally or alternatively, the system further includes user input module which allows users to update the dataset. Optionally, a graphical user interface (GUI) that is optionally available in a website hosted by a web server, includes a form that allows users to provide new linguistic elements, add, edit, remove, or update descriptive information of new and existing linguistic elements, and/or define contextual characteristics of new and existing linguistic element. Additionally or alternatively, the system data pertaining to linguistic elements is updated according to inputs of various users, for example as described below.

Before explaining embodiments of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

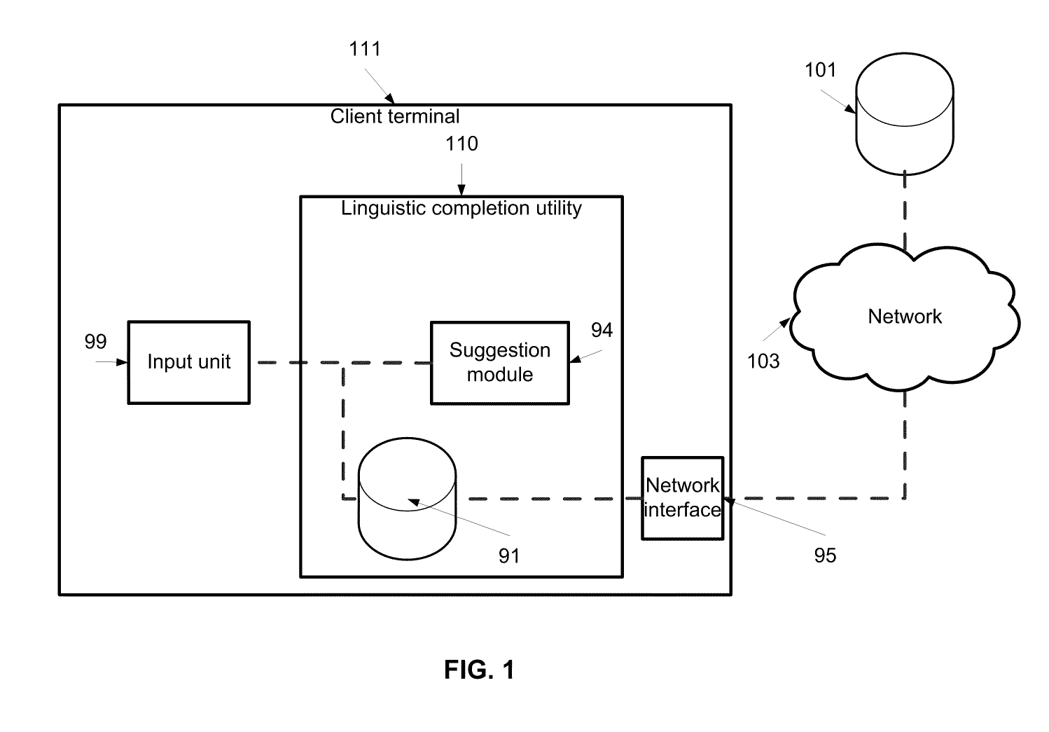

Reference is now made to FIG. 1, which is a schematic illustration of a client terminal 111 having a linguistic completion utility 110 of providing one or more completion suggestions, according to some embodiments of the present invention. As used herein, a linguistic element means a word, a tag of an operation, such as a voice operated action, a contact name, a website, a sentence, a figure of speech, an expression, and a symbol indicative of a linguistic element, for example an emoticon and the like. The client terminal 111 may be any client terminal having an input unit 99 for inputting data, for example by typing, such as a laptop, a Smartphone, a cellular phone a tablet, a personal computer a personal digital assistance (PDA) and the like. The linguistic completion utility 110 may be an add-on module, such as an add-on installed in a word processor and/or a browser installed in the client terminal 111, an independent module which identifies partial linguistic elements inputted by a user, and/or a web based application which is loaded which the user access a certain address, for example as an active server page (ASP) application or an ASP.NET application. In such an embodiment, the linguistic completion utility 110 is hosted in a web server and accessed over the stateless HTTP protocol. The linguistic completion utility 110 may identify a character immediately following a typing command. As used herein, typing means any form of inputting characters, for example typing, selecting, converting and the like. Optionally, the client terminal 111 comprises a voice to text module (not shown) or an image to text module that allows converting audio and/or images to text. In such embodiments, linguistic elements mean audio segment and/or images. Optionally, client terminal 111 provides one or more completion suggestions for character strings which are not linguistic, such as telephone numbers and hyperlinks. For brevity, these non linguistic elements may be referred to herein as linguistic elements.

The linguistic completion utility 110 includes or connected to a local repository 91 which is hosted by the client terminal 111 and stores a dataset, such as a list, a matrix, an array, and/or a complex of arrays that includes a plurality of linguistic element entries, optionally arranged and/or segmented according to a lexicographic order. This dataset may be a copy of a dataset stored in a remote repository 101 which is connected thereto, using a client terminal network interface 95 via network 103, for example as described below. Each linguistic element entry includes a linguistic element and optionally an identification tag, such as a unique value. Each linguistic element is associated with descriptive information such as translation, meaning, spelling, pronunciation, grammatical data, explanation, references to descriptive sources, for example hyperlinks, an image, a video, an audio file and any combination thereof. The descriptive information is set to be presented, for example displayed, to a user typing the partial linguistic element, allowing him to select automatic completion to the partial linguistic element, for example as described below. The client terminal 111 further includes a suggestion module 94 set to match partial linguistic elements, such as the first two, the first three, the first four and/or the first more letters of a linguistic element with linguistic element entries to identify a matching set. The partial linguistic elements are received via an input unit 99, such man machine interface (MMI), for example a keyboard, a touch screen and/or an interface, such as a network interface, for example as described below.

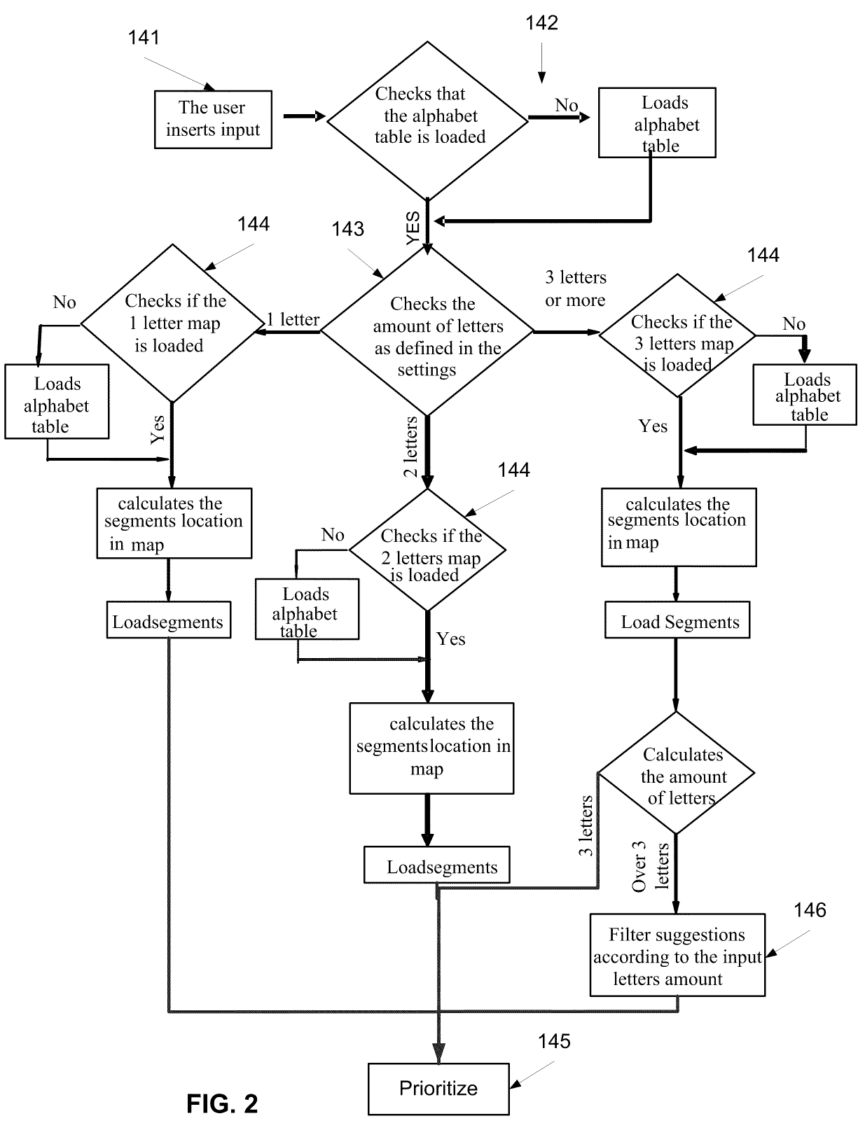

Reference is now also made to FIG. 2, which is a flowchart of a method of providing a set of linguistic elements as completion suggestions, according to some embodiments of the present invention. The method is based on a dataset, such as the dataset stored in the local repository 91, of a plurality of linguistic element entries and a plurality of character segmentation maps, optionally three, each segmenting a dataset of linguistic element entries to segments having common opening characters. Each character segmentation map is optionally a set of references, such as pointers and/or identification tags, which indicates which entries relate to which segment. Optionally, the first character segmentation map segments the linguistic element entries to segments according to a common first character, the second character segmentation map segments the linguistic element entries to segments according to common first and second characters, and the third character segmentation map segments the linguistic element entries to segments according to common first, second, and third characters. In English, the first character segmentation map has 26 segments, the second character segmentation map has 26²=676 segments, and the third character segmentation map has 26³=17,576 segments. The computational complexity of matching a segment is O₍₁₎.

First, as shown at 141, at least a partial linguistic element is received from the user, for example as described above. Then, as shown at 142, an access to a dataset that includes the linguistic element entries is verified. Now, as shown at 143, the number of characters in the partial linguistic element is checked. Accordingly, one of the character segmentation maps is selected, for example the character segmentation maps of 1 character, 2 characters and/or 3 characters. Optionally, if the partial linguistic element has more than 3 characters, the linguistic elements in the respective segment are filtered according to their characters, for example as known in the art. As shown at 144, the selected character segmentation map is used for comparing the partial linguistic element with the segments it defined so as to find a matched segment. The entries of the matched segment are used as completion suggestions. Now, as shown at 145, the entries of the matched segment are prioritized, optionally according to contextual characteristics of the partial linguistic element. Optionally, the prioritization is performed according to a dataset of linguistic element entries; each includes or associated with dynamic measurements indicative of a plurality of contextual characteristics related to a respective linguistic element. The dataset, as further described below, is optionally stored in a central database. Optionally an indication of the matched segment is sent to a central system that responds with a prioritization of the members of the segment. As only an indication of the segment is sent and not all the members of the matching segment, the bandwidth required for providing completion suggestions by the linguistic completion utility 110 is reduced.

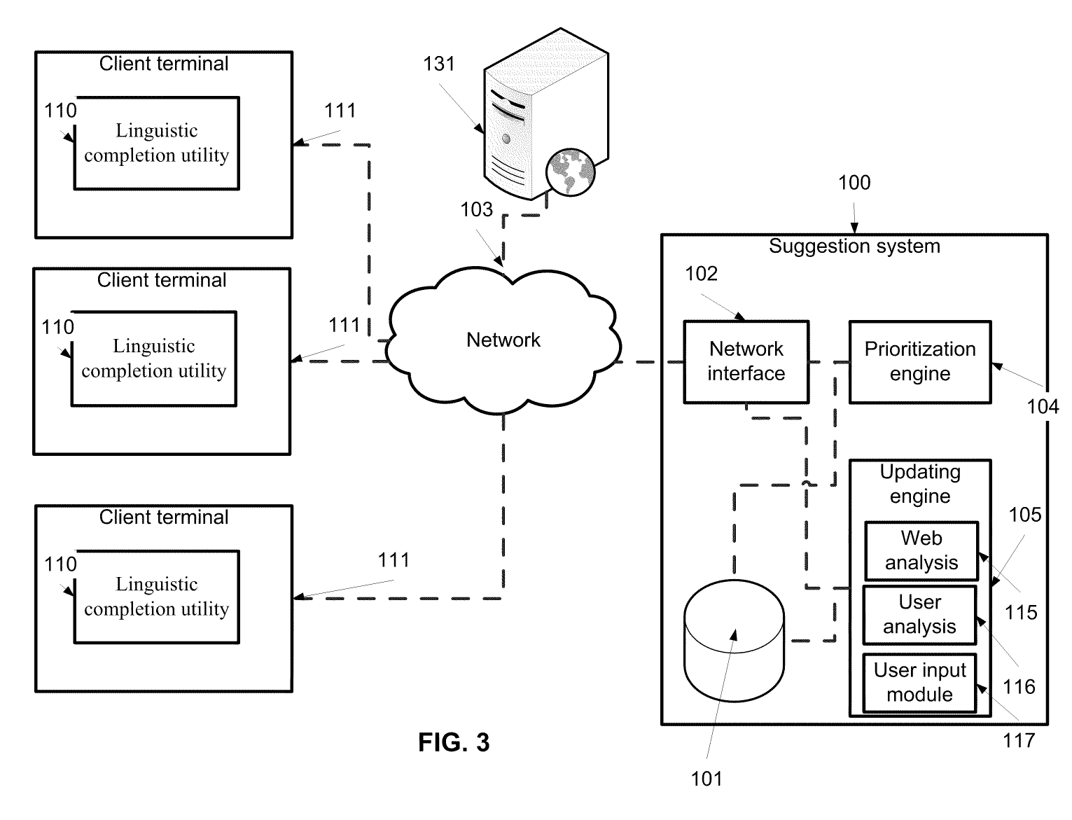

Reference is now made to FIG. 3, which is a schematic illustration of a plurality of client terminals, optionally each as depicted in FIG. 1, which are connected to a system 100 of prioritizing linguistic elements according to contextual characteristics of a partial linguistic element, according to some embodiments of the present invention. Optionally, the repository 101 hosts linguistic element entries in one or more data servers which are connected to the network 103. The system 100 includes the repository 101 with aforementioned central database. The system 100 further includes an input interface for receiving a set of linguistic elements or an indication about such a set, for example the aforementioned matched segment, an updating engine 105 that updates the dynamic measurements documented in the central database and a prioritization engine 104 that prioritizes the received set. The prioritization may be performed by arranging and/or classifying the matching linguistic element entries according to the similarity of the dynamic measurements to contextual characteristics of the partial linguistic element. The system 100 may be hosted in a computing unit, such as a network node, which is connected to the plurality of client terminals 111 via the network 103. In such an embodiment, the system 100 includes a network interface 102 includes a physical network port, a physical layer (PHY) 128 connection, a network interface card (NIC) interface, a web service, and/or a file transfer protocol (FTP) which is used as a point of connection with a communication network 103, such as the internet. The network interface 102 allows communicating with the linguistic completion utilities 110 which are installed and/or hosted by one of the client terminals 111.

Optionally, a matched segment is identified locally by a suggestion module 94 of the linguistic completion utility 110 and sent for prioritization by the prioritization engine 104. The matched segment or identification thereof is sent together with contextual characteristics of the related at least partial linguistic element.

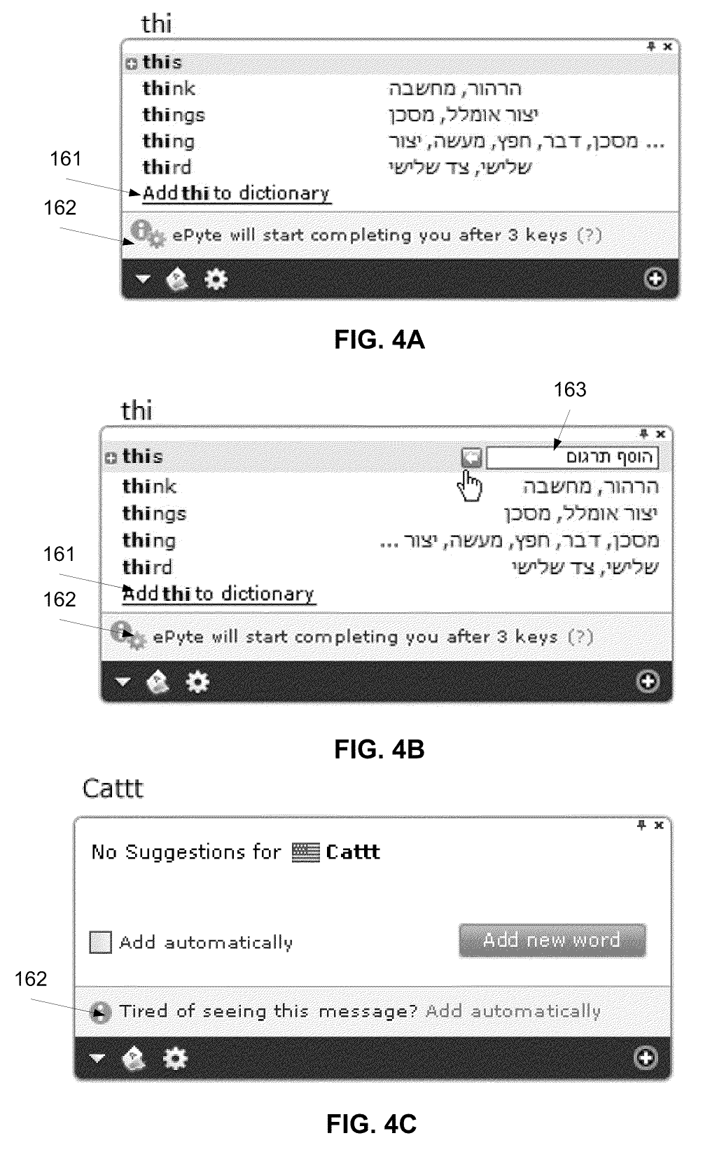

In such an embodiment, a tag indicative of the matched segment may be sent to reduce the needed bandwidth. The prioritization engine 104 now arranges, scores, classifies and/or otherwise priorities the linguistic elements in the matched set according to the contextual characteristics of members of the set. The prioritized set, or indication about the prioritizing, is sent to the linguistic completion utility 110 that presents it to the client accordingly. For example, FIG. 4A depicts a window in which the prioritized set of linguistic elements, which are selected in response to the partial linguistic element “thi”, are presented to the user. The presentation of each linguistic element includes a presentation of related descriptive information, for example as defined in the respective entry a notification bar 162 which may be used for providing data to the user. Optionally, the notification bar 162 allows adding promotional content which is targeted to the user, for example according to an analysis of the respective partial linguistic element and/or the user profile. Optionally, as shown at 163 of FIG. 4B, the window includes a rubric that allows adding descriptive information pertaining to one or more of the completion suggestions. Optionally, if no completion suggestion is available a designated window is presented to the user, for example as shown at FIG. 4C. Optionally, the window includes a button that allows the user to access a website, a webpage, and/or any interface that allows inputting data, for example a repository, as shown by numeral 161 of FIG. 4C.

In another embodiment, the prioritization engine 104 may receive at least partial linguistic element from the network interface 102 and select one or more of the plurality of linguistic elements in the repository 101 accordingly, for example similarly to the suggestion engine module 94. For example the selection is performed by matching between the partial linguistic element and the plurality of linguistic elements. Optionally, the selection is performed by identifying a matching segment of linguistic elements using one or more of the character segmentation maps, for example as described above. The matching linguistic elements may be referred to herein as a matched set of linguistic elements.

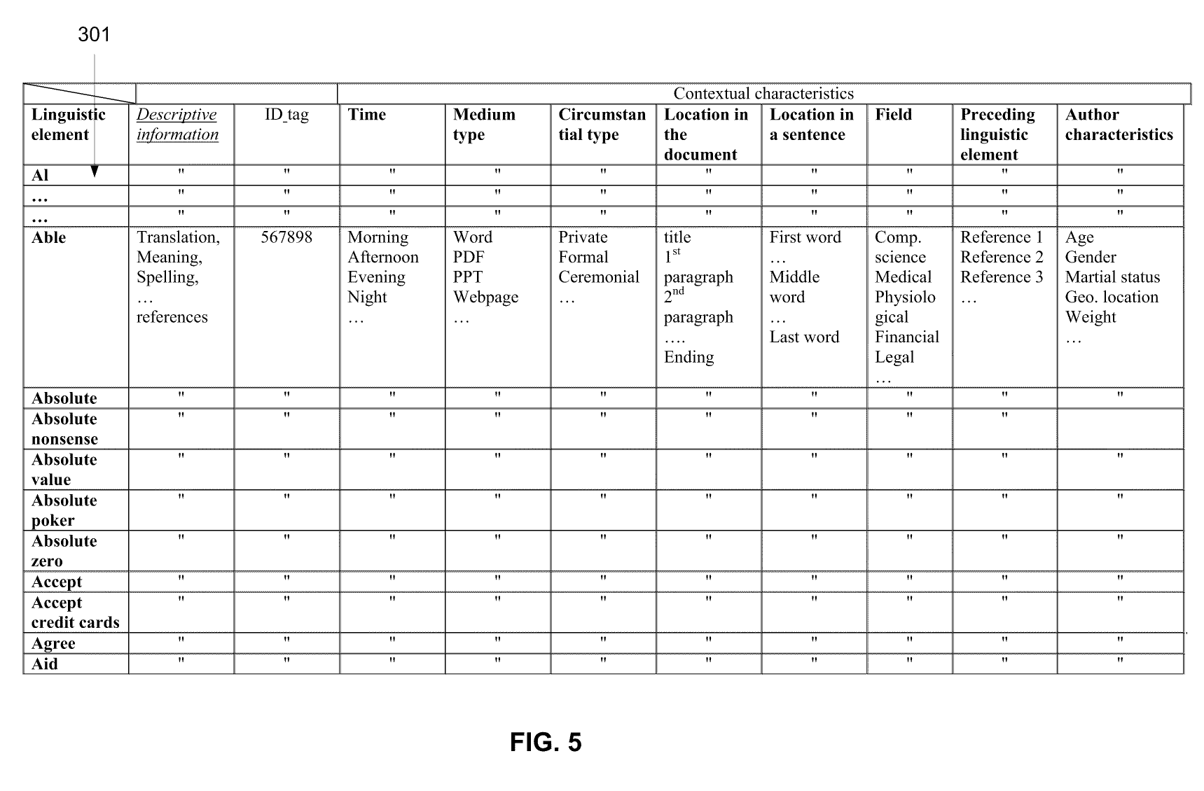

Reference is now also made to FIG. 5, which is an exemplary schematic illustration of an array of linguistic elements 301 and the dynamic measurements of their contextual characteristics, according to some embodiments of the present invention. The dynamic measurements of the contextual characteristics are optionally updated by the updating engine 105 that is connected to the repository 101.

As outlined above, the system 100 provides one or more completion suggestions according to contextual characteristics of at least partial linguistic element identified by the linguistic completion utilities 110 and installed in the client terminals 111. The system 100 provides suggested linguistic elements which are arranged classified or otherwise prioritized by processing their contextual characteristics in light of the contextual characteristics of the partial linguistic element.

Optionally, the updating engine 105 updates the contextual characteristics according to an analysis of a plurality of sources, such as user inputs, user documents, and/or an analysis of network documents. As used herein, a network document means a webpage, a media file, a data file, a peer to peer (P2P) transmission, a search query, a response to a search query, a content retrieved in response to a search query, and a resource pointed by a universal resource identifier (URI). A document means any document which is created by inputs of a user, for example a form in a webpage, a WORD document, a portable document format (PDF) document, a presentation, and the like.

Optionally, the updating engine 105 includes a web analysis module 115 which analyzes a plurality of network documents to estimate the contextual characteristics of some or all of the linguistic elements.

Additionally or alternatively, some or all of the linguistic completion utility 110 includes a user analysis module 116 which analyzes a plurality of user documents to estimate the contextual characteristics of some or all of the linguistic elements which are typed or otherwise inputted by him. The linguistic completion utility 110 may generate a local user dataset, stored in the local repository 91, which is optionally similar to the array of linguistic elements 301. The local user dataset is optionally sent to the use analysis module 116, allowing it to update the array of linguistic elements 301 accordingly and/or to store the user data set for future use.

Additionally or alternatively, the updating engine 105 includes a user input module 117 which allows users to update the array of linguistic elements 301. Optionally, a GUI that is optionally available in a website hosted by a web server 131, includes a form that allows users to provide new linguistic elements, add, edit, remove, or update descriptive information of new and existing linguistic elements, and/or define contextual characteristics of new and existing linguistic element. For example, the GUI allows a user to input or select a certain linguistic element and allows a user to provide descriptive information pertaining to the certain linguistic element and/or to specify estimations pertaining to various contextual characteristics of the certain linguistic element. For instance, the user may set his estimation on a on a scale which is designated to a certain contextual characteristic and/or provide descriptive information in a designated form. The user input module 117 is optionally connected to the web server, for example via the network 103. Optionally, the GUI in which the linguistic completion utility 110 presents the completion suggestions received from the system 100 includes a link to the website, a webpage, and/or any interface that allows inputting data, for example a repository, as shown by numeral 161 of FIG. 4A.

Each linguistic element entry in the repository 101, which may be represented as a vector or a matrix, includes a plurality of dynamic measurements each pertaining to a different contextual characteristic. Each dynamic measurement is indicative of the prevalence a certain contextual characteristic of the linguistic element in a plurality of documents, such as user and/or network documents. Optionally, the dynamic measurements are updated according to a statistical analysis of the documents and/or a statistical analysis of a plurality of user histories. The dynamic measurements may be expressed in numerical values, percentages, relative ranking and the like. For example, if the contextual characteristic is input time, and 200 user documents with the linguistic element “good day” have been analyzed, 100 inputted in the morning, 50 in the evening, 30 at night, and 20 in an unknown hour, the dynamic measurements may be morning=0.5, after noon=0, evening=0.25, and night=0.15. The entries are updated, randomly, periodically, and/or sequentially by the user input module 116 and/or the web analysis module 115. For example, the web analysis module 115 may automatically crawl the network, for example following a list of hyperlinks to a plurality of network documents, to identify the contextual characteristics of various linguistic elements in a plurality of web pages, and update the respective linguistic element entries accordingly. In another example, the user input module 116 may receive data pertaining to contextual characteristics of various linguistic elements used in documents of various users with different user profiles and updates the respective linguistic element entries accordingly.

Each linguistic element entry, for example linguistic element vector, includes dynamic measurements of one or more of one or more of the following contextual characteristics:
1. Time—the prevalence of the linguistic element in documents created in a certain period of the day. The dynamic measurement may be indicative of the prevalence of the linguistic element per hour of the day, per part of the day, for example morning, noon, afternoon, evening, and/or night, per time of the week, for example per day, per time of the month, for example beginning and/or and of the year, and per time of the year. The time contextual characteristic may be estimated by analyzing the time in which the respective linguistic element has been inputted. For example, the estimation may be by detecting the time in which blog posts, which include the respective linguistic element, have been posted. In another embodiment, the estimation is performed by the time the linguistic element has been typed in user documents, for example as recorded by various linguistic completion utilities, such as 110, for example as described below.
2. Medium type—the prevalence of the linguistic element in documents of a certain medium type, for example in WORD documents, emails, PDF documents, presentations, webpage forms, and the like. The medium type may be determined by analyzing the filename extensions of a plurality of network documents with the linguistic element.
3. Circumstantial type—the prevalence of the linguistic element in documents of a certain circumstantial type, such as formal documents, personal documents, sketch documents and the like. The circumstantial type may be detected by analyzing the content of a plurality of network documents with the linguistic element according to various automated methods for document classification, for example using an ontology which expresses terminology information and vocabulary, for example see Mu-Hee Song et al, An Automatic Approach to Classify Web Documents Using a Domain Ontology, Springer Berlin/Heidelberg ISSN 0302-9743 (Print) 1611-3349 (Online Volume 3776/200), Book Pattern Recognition and Machine Intelligence, 10.1007/11590316 and Chul Su Lim et al, Multiple sets of features for automatic genre classification of web documents Multiple sets of features for automatic genre classification of web documents, Information Processing and Management: an International Journal, Volume 41, Issue 5 (September 2005), Pages: 1263-1276, 2005, ISSN:0306-4573, which are incorporated herein by reference.
4. Location in the document—the prevalence of the linguistic element in a certain location in a created document, for example in the title of the document, for example the header of a document or a title of an email, an opening paragraph of a document, a kernel paragraph of a document, a final paragraph of a document, a footnote of a document, a remark, and the like. The location may be determined by analyzing the textual content of a plurality of network documents with the linguistic element.
5. Location in a sentence—the prevalence of the linguistic element in a certain place in a sentence, for example the opening word of a sentence, a kernel word of sentence, a final word in a sentence, and the like. The location may be determined by analyzing the textual content of a plurality of network documents with the linguistic element.
6. Field—the prevalence of the linguistic element in documents classified as related to a certain field, such as law, medicine, blog, nonsense, news, social science, computer science and the like. The field may be detected by analyzing the content of a plurality of network documents with the linguistic element according to various automated classification methods, for example as described above in relation to the circumstantial type contextual characteristic.
7. Preceding linguistic element—the prevalence of the linguistic element in documents having a certain preceding word. The preceding linguistic element may be stated by a link to another linguistic element entry. The preceding linguistic element may be detected by analyzing the textual content of a plurality of network documents with the linguistic element.
8. Author characteristic—the prevalence of the linguistic element in documents created by users having one or more common characteristics, such as age, gender, origin, geographic location, family status, occupation, and/or any other demographic characteristic. The author characteristic may be detected by analyzing the user profiles of users creating a plurality of documents. This data may be acquired using the linguistic completion utility 110 which are installed in a plurality of different client terminals, designated modules and/or a user profile database which is updated according to an analysis of documents created by a plurality of users.

Optionally, each linguistic element entry documents general characteristics, such as relative prevalence in analyzed document, estimated prevalence according to linguistic databases, and the like.

Optionally, each one of the contextual characteristics is weighted according to its relative impotence for prioritizing linguistic elements. The weight may be manually adjusted by each one of the users for his purposes and stored in his user profile. The adjustment may be performed using a designated GUI managed and/or accessed by the linguistic completion utility 110 and/or set by the operator.

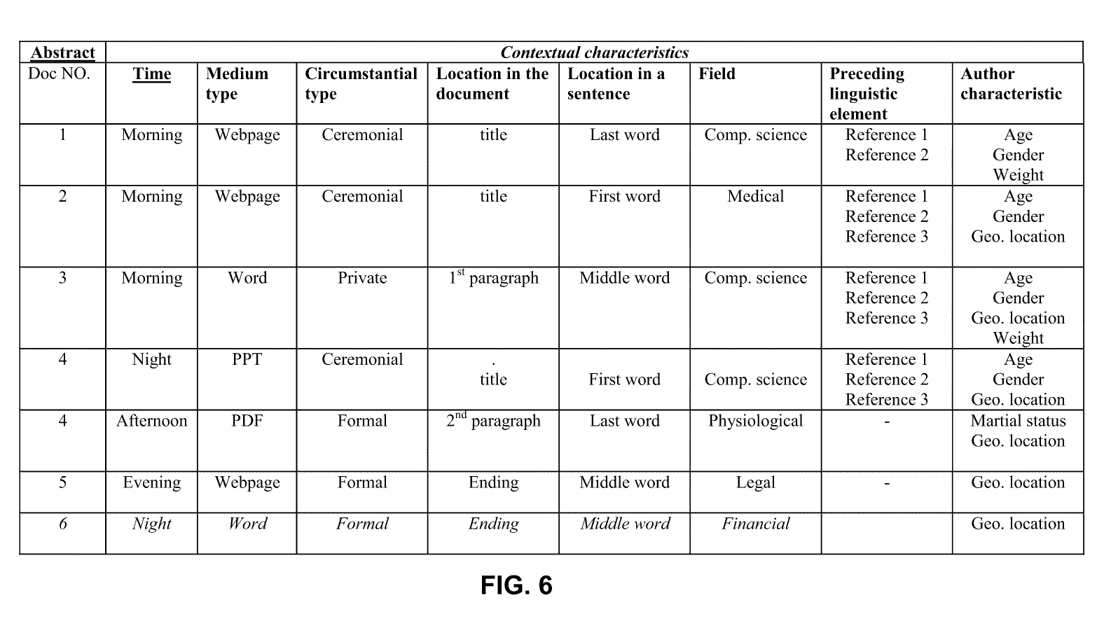

Optionally, each linguistic element entry includes a matrix or another dataset in which a plurality of appearances of the related linguistic element in a plurality of documents is documented. In each appearance, an indication about one or more of the above contextual characteristics is recorded, for example as shown in FIG. 6 which is an exemplary table of six exemplary appearances of the linguistic element “abstract”. This allows calculating dynamic measurements for different groups selected according to one or more of the contextual characteristics. For example, a group may be defined as a group of appearances in which the related linguistic element appears in documents of the field of literature, a group of appearances in which the related linguistic element appears in documents of the field of social sciences, a group of appearances in which the related linguistic element appears in documents drafted during the morning and the like. In such a manner, a dynamic measurement may be calculated for different groups. For example, the location of the word “virus” in a sentence may be calculated separately for documents in the field of biotechnology and for documents in the field of computer science. In another example, the time of inputting of the word “Magic” may be calculated separately for personal documents and formal documents. In another example, the location of the word “happy” in a sentence may be calculated separately for documents created by users in the age of less than 18 and for documents created by users in the age of more than 18. The ability to calculate dynamic measurements of contextual characteristics of different groups allows providing a completion suggestion which is adapted to the context in which the partial linguistic element is inputted. The suggestions are calculated according to data from a plurality of documents have similar characteristics to the document in which the partial linguistic element is inputted.

It should be noted that the dynamic measurements in the dataset are updated according to an analysis of a plurality of documents, completion suggestions which are calculated according to the dataset reflect up to date usage. In such a manner, the user receives completion suggestions which have been actually used in a plurality of documents having similar contextual characteristics and may be related to current events which are documented in the analyzed webpages. Optionally, the dynamic measurements are calculated in a manner that new appearances have more weight than old appearances.

Optionally, each linguistic element is assigned with an actuality weight. Each appearance of the linguistic element in one of the user and/or network documents and/or inputs is assigned with a time decreasing weight. The weights are stored in the memory and sequentially and/or periodically resumed to create the actuality weight of the linguistic element. In such a manner, the linguistic element is prioritized in a manner that old appearances thereof have less effect than new appearances thereof.

According to some embodiments of the present invention, the linguistic completion utility 110 includes an analysis module that is set to extract contextual characteristics pertaining to the partial linguistic element selected completion, for example to the user who inputs the partial linguistic element. Optionally, the analysis module extracts the time in which the partial linguistic element is typed, for example from the clock of the operating system. The extracted time is then marked as a time contextual characteristic of the partial linguistic element. Optionally, the analysis module extracts the medium type of the document in which the partial linguistic element is typed, for example by determining in which application it is being typed. The extracted medium is then marked as a medium contextual characteristic of the partial linguistic element. Optionally, the analysis module extracts the circumstantial type of the document in which the partial linguistic element is typed. Optionally, the circumstantial type is determined by analyzing the title and/or the opening of the document in which the partial linguistic element is typed. For example, if the title and/or the opening includes the linguistic element “RE:”, “Reference Number”, “To whom it may concern”, “Our number”, “in response”, and the like the document is tagged as a business document and if the do title and/or the opening includes linguistic elements such as “love”, “friend”, and colloquial language is tagged as a personal document. Optionally, when the partial linguistic element is provided from a content of a typed email, the analysis module detects the addressee of the email, for example by analyzing the “To” box, and matches it with a list that define the type of each contact to determine whether it is a private or business contact. The extracted circumstantial type is then marked as a circumstantial type contextual characteristic of the partial linguistic element. Optionally, the analysis module extracts the location in the document of the document in which the partial linguistic element is typed. Optionally, the analysis module detects the location by analyzing the email in which the partial linguistic element is typed, for example whether it is in the title of an email, an opening paragraph of a WORD document, a last slide of a presentation, a certain form in a multi form document and the like. The extracted location is then marked as a document location contextual characteristic of the partial linguistic element. Optionally, the analysis module extracts the location in the sentence in the document in which the partial linguistic element is typed. Optionally, the analysis module detects the location in the sentence by monitoring and analyzing the typing in real time. A sentence is optionally defined between dots. The extracted location in the sentence, for example beginning, middle, and/or end, similarly to the described above, is then marked as a sentence location contextual characteristic of the partial linguistic element. Optionally, the analysis module extracts the field of the document in which the partial linguistic element is typed. Optionally, the field is determined according to the user profile, for example according to his occupation. Optionally, the field is determined by analyzing the title of the document in which the partial linguistic element is typed. For example, the presence of legal and/or medical keywords may be used to mark the field of the document as legal and/or medical. Optionally, the analysis module detects the preceding linguistic element in the sentence are detected by monitoring and analyzing the typing of the user in real time. The typed linguistic elements may be locally stored in a designated queue and/or buffer. The preceding linguistic elements in the sentence are marked and associated with the partial linguistic element. Optionally, the analysis module detects characteristics of the user which types the partial linguistic element, for example by extracting data from a user profile. The extracted characteristics are marked as author characteristics of the document in which the partial linguistic element is typed.

Additionally or alternatively, one or more user profiles are associated with each linguistic completion utility 110. Each user profile includes the author characteristics of a user that uses the respective client terminal, for example demographic characteristics thereof, as described above. Optionally, the user profile defines the field of the document created while the user inputs, for example types, the partial linguistic element. The field may be time dependent, for example, biotechnology during morning time, literature during evening time, and science fiction during night time. Such a time dependency may be manually set by the user, for example using a designated GUI, similarly to the described above.

The contextual characteristics, which are identified by the analysis module and/or set in the user profile, are optionally forwarded to the prioritization engine 104 together with the partial linguistic element. The prioritization engine 104 arranges, scores, classifies and/or otherwise priorities the linguistic elements in a set of linguistic elements selected as matching to the partial linguistic element.

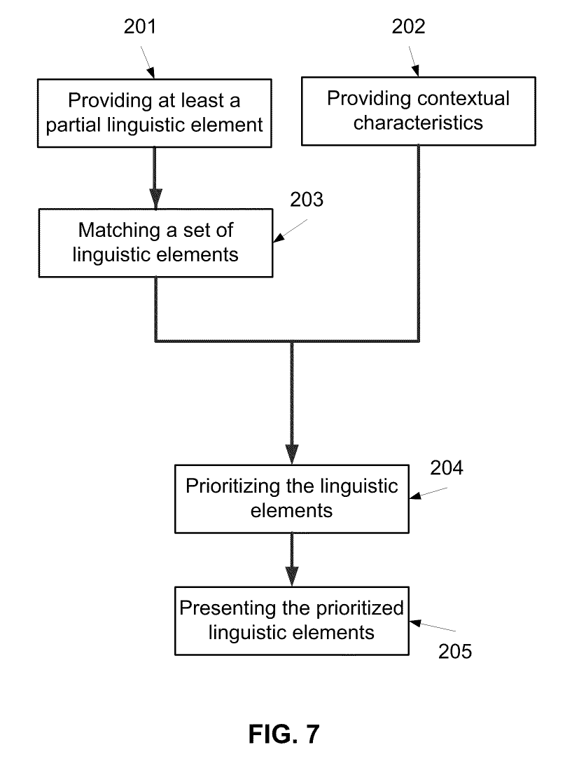

Reference is now also made to FIG. 7, which is a flowchart of a method of providing one or more completion suggestions in response and according to at least a partial linguistic element, according to some embodiments of the present invention.

As shown at 201 and 202 at least a partial linguistic element and one or more contextual characteristics thereof are provided. Optionally, the linguistic completion utility 110 detects at least partial linguistic element, for example by monitoring the typing of a user in a certain application and the analysis module of the linguistic completion utility 110 detects the one or more contextual characteristics, for example as described above. Than, the linguistic completion utility 110 sends the at least partial linguistic element and the one or more contextual characteristics thereof to the network interface 102 that forwards it to the prioritization engine 104.

Now, as shown at 203, the prioritization engine 104 and/or the suggestion module 94 matches the partial linguistic element with the records in the repository 101 to identify a matched set of linguistic elements, for example using one or more character segmentation maps. The matched set of linguistic elements includes linguistic elements with similar opening characters in a similar order. Optionally, the prioritization engine 104 and/or the suggestion module 94 add synonyms of linguistic elements in the set to the set. The addition may be performed using a synonym map and/or index.

Than, as shown at 204, the match linguistic elements are prioritized according to the one or more contextual characteristics of the partial linguistic element. Optionally, each linguistic element in the set is scored according to a match between a respective the linguistic element vector that includes contextual characteristic dynamic measurements and the one or more contextual characteristics which are related to the partial linguistic element and provided as described above. For example, if the partial linguistic element has contextual characteristics, such as Time=morning and Medium type=email, the linguistic elements in the set with high Time and Medium type dynamic measurements receive a higher score than the linguistic elements in the set with lower Time and/or Medium type dynamic measurements. As described above, the dynamic measurements of each linguistic element vector or entry in the repository may be created according to an analysis, such as a statistical analysis that is based on a plurality of documents, such as user and/or network documents. In such a manner, the dynamic measurement is indicative of an actual usage of the respective linguistic element. Therefore, the dynamic measurement is an indication of how the respective linguistic element is actually being used. Moreover, as the linguistic element entry documents the contextual characteristics of different groups of documents, selected according to a common characteristic such as field and/or circumstantial type, linguistic element entries may be used for providing completion suggestion which are adapted to characteristics of the user who inputs the partial linguistic element and/or the characteristics of the document in which the partial linguistic element is typed.

Optionally, different dynamic measurements are ranked differently. For example, the Time dynamic measurement may have a lower weight than the Field dynamic measurement. For example, the score is calculated for M linguistic elements as follows:

Score(leₘ)=C₁W₁+C₂W₂+C₂W₂+ . . . CₙWₙ

where leₘ denotes a linguistic element which is in the m place in an order of M linguistic elements, Cₙ denotes a dynamic measurement of a contextual characteristic in the n place in an order of N dynamic measurements, and Wₙ denotes a weight assigned to Cₙ.

Optionally, the prioritization is performed according to the usage history of the inputting user. In such an embodiment, the linguistic completion utility 110 records the linguistic elements which are used by the user and optionally scores them according to their usage prevalence. Optionally, the prioritization is performed also according to the grammatical suitability of the linguistic elements to the sentence from which the partial linguistic element is taken.

Now, as shown at 205, the prioritized set or an indication pertaining to the prioritized set is outputted, for example sent and/or forwarded, to the linguistic completion utility 110 for presentation. This allows presenting the members of the set according to the prioritization. Optionally, only the linguistic elements with the highest priority are sent for presentation, for example the top five, top ten, top twenty, and/or any higher or intermediate number.

It is expected that during the life of a patent maturing from this application many relevant system and methods will be developed and the scope of the term entry, repository, server, and computing unit is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of acquiring at least one completion suggestion to a partial linguistic element, comprising:
detecting a user input having at least a partial linguistic element;
selecting a group from a plurality of linguistic elements according to said partial linguistic element, each member of said group having at least one common character with said partial linguistic element;
identifying at least one contextual characteristic of said partial linguistic element;
prioritizing members of said group according to a match between said at least one contextual characteristic and a dataset mapping a plurality of contextual characteristics of each said linguistic element; and
presenting at least some of said prioritized members as at least one completion suggestion to said partial linguistic element.

2. The method of claim 1, wherein said selecting comprises receiving a descriptive information for each said linguistic element from a plurality of users, said presenting comprises presenting descriptive information of said at least some of said prioritized members.

3. The method of claim 1, wherein said detecting comprises converting a voice signal to generate said partial linguistic element.

4. The method of claim 1, wherein said selecting comprises providing at least one map segmenting said plurality of linguistic elements according to opening characters and selecting a segment of said map as said group according to said partial linguistic element.

5. The method of claim 1, wherein said identifying comprises identifying an input time of submitting said user input, said dataset mapping a plurality of input times of each said linguistic element according to an analysis of a plurality of documents.

6. The method of claim 1, wherein said identifying comprises identifying a medium type in which said user input being provided, said dataset mapping a prevalence of plurality of types of a plurality of documents in which each said linguistic element being identified.

7. The method of claim 1, wherein said identifying comprises classifying a circumstantial type of a document in which said user input being provided, said dataset mapping a prevalence of plurality of circumstantial types of a plurality of documents in which each said linguistic element being identified.

8. The method of claim 1, wherein said identifying comprises classifying a field of a document in which said user input being provided, said dataset mapping a prevalence of plurality of fields of a plurality of documents in which each said linguistic element being identified.

9. The method of claim 1, wherein said identifying comprises identifying a location in a document for which said user input being provided, said dataset mapping a prevalence of said linguistic element in a plurality of locations in a plurality of documents.

10. The method of claim 1, wherein said identifying comprises identifying a location in a sentence in which said user input being provided, said dataset mapping a prevalence of said linguistic element in a plurality of locations in a plurality of sentences in a plurality of documents.

11. The method of claim 1, wherein said identifying comprises identifying at least one characteristic of a user inputting said user input, said dataset mapping a plurality of author characteristics of a plurality of documents in which each said linguistic element being identified.

12. A method of providing at least one completion suggestion in response to a partial linguistic element, comprising:
providing a group selected from a plurality of linguistic elements, each member of said group having at least one common character with at least a partial linguistic element of a user input;
providing at least one contextual characteristic of said partial linguistic element;
matching said at least one contextual characteristic with a dataset having a plurality of entries mapping a plurality of contextual characteristics of each said linguistic element;
prioritizing members of said group according to said match; and
indicating said prioritization to allow a presentation of said group accordingly.

13. The method of claim 12, wherein providing at least one contextual characteristic comprises providing a user profile defining at least one characteristic of a user providing said user input said matching comprises matching said user profile with said dataset.

14. The method of claim 12, wherein said matching comprises adding at least one synonym of a linguistic element of said group to said group.

15. The method of claim 12, wherein said providing comprises receiving said group from a linguistic completion utility hosted in a client terminal.

16. A system of providing at least one completion suggestion to a partial linguistic element, comprising:
a repository which stores a dataset having a plurality of entries mapping a plurality of contextual characteristics of each of a plurality of linguistic elements;
a web analysis unit which analyzes a plurality of network documents to update said dataset;
an interface which receives at least one contextual characteristic of at least a partial linguistic element and an indication of a group of said plurality of linguistic elements, said group being selected according to said partial linguistic element; and
a prioritization engine which priorities members of said group according to a match between said at least one contextual characteristic and a respective group of said plurality of entries.

17. The system of claim 16, wherein each said network document is selected from a group consisting of a webpage, a media file, a data file, a peer to peer (P2P) transmission, a search query, a response to a search query, a content retrieved in response to a search query, and a resource pointed by a universal resource identifier (URI).

18. The system of claim 16, wherein said at least one contextual characteristic and said indication are received from one of a plurality of linguistic completion utilities installed on a plurality of client terminals communicating with said interface.

19. The system of claim 16, further comprising a user analysis module which analyzes a plurality of documents composed by a plurality of users to update said dataset.

20. The system of claim 16, further comprising a user input module which receives a plurality of manual inputs from a plurality of users and updates said dataset accordingly.

21. A method of maintaining a repository of a plurality of linguistic elements for prioritizing, comprising:
providing a dataset having a plurality of entries mapping a plurality of contextual characteristics of each of a plurality of linguistic elements;
analyzing a plurality of documents created by a plurality of different users to statistically estimate the prevalence of at least one of said plurality of contextual characteristics for each said linguistic element; and
updating said dataset according to said estimation.

22. The method of claim 21, wherein said analyzing comprises assigning each said estimation with a time decreasing weight so that the effect of each appearance of said linguistic element depends on its actuality.

23. The method of claim 21, wherein said analyzing comprises monitoring a usage of said plurality of linguistic elements by each of said plurality of users during typing.

24. The method of claim 21, wherein said analyzing comprises analyzing a plurality of webpages having at least some of said plurality of linguistic elements.
